(19) United States
(12) Patent Application Publication
(10) Pub. No.: US 2003/0211208 A1
(43) Pub. Date: Nov. 13, 2003

(54) Method of preserving fish

(76) Inventor: Ronald N. Goodman, Brookeville, MD (US)

Correspondence Address: Barnes & Thornburg, Suite 900, 750 17th Street NW, Washington, DC, 20006, US

(21) Appl. No.: 10/362,889

(22) PCT Filed: Aug. 28, 2001
(86) PCT No.: PCT/US01/26698

(51) Int. Cl. C12H 1/10

(52) U.S. Cl. 426/321

(57) ABSTRACT

The present invention is a dip for preserving fish. It includes the following ingredients: lactic acid, sodium phosphate, cultured dextrose, vitamin C, vitamin E7, carnosic acid, rosamarinic acid, citric acid and honey and salt. The dip may be provided in a liquid, for example, water, and used as a bath.

### BACKGROUND AND SUMMARY OF THE INVENTION

The present invention is directed to preserving or extending the shelf life of fish and more specifically, to a wash and packaging of fish to extend its shelf life.

Fish are generally processed as follows. First, the exterior of the fish is washed by water under pressure. Then the fish is filleted and dipped in a bath. The fish may be packaged in a modified atmosphere packaging which generally includes mixtures of gases.

The bath generally includes water with different ingredients for extending the shelf life of the fish. These have included one of 2% lactic acid, a combination of sodium phosphate and salt, and Duralox, available from Kalse (a combination of Vitamin C, Vitamin E, citric acid and rosemary extract( carnosic and rosamarinic acids)). The gases generally include some combination of nitrogen, oxygen and carbon dioxide.

Depending upon the ingredients used in the wash, the packaged fish generally has a shelf life of up to about eight days. Some, depending upon the cleanliness of the processing, have experienced 10-14 day shelf life. The present invention is directed to extending the shelf life between 14-18 days. Although the shelf life is longer than 14-18 days with respect to health concerns, the fish may change its look and feel and thus, be commercially unacceptable.

The present invention is a dip for preserving fish. It includes the following ingredients: lactic acid, sodium phosphate, cultured dextrose, vitamin C, vitamin E, carnosic acid, rosamarinic acid, citric acid and honey and salt. The dip may be provided in a liquid, for example, water, and used as a bath. The filleted fish is dipped in the bath. The fish may be precleaned by an exterior wash of water under pressure and/or a quick preliminary dip in the wash of activated chlorined oxide. The wash may also include flavorings, for example, lemon extract or colorants, for example, canthaxantin. The fillet is dipped in the bath for a sufficient amount of time to preserve the fish for at least 14 days without packaging. To further extend the life of the fish, it may be packaged in an atmosphere having a combination of nitrogen, oxygen and carbon dioxide.

Other objects, aspects and novel features of the present invention will become apparent from the following detailed description of the invention.

### DETAILED DESCRIPTION OF THE PREFERRED EMBODIMENTS

The present invention also begins the process with an exterior wash of water under pressure. The fish is filleted and then dipped in a bath. A quick preliminary dip in a wash of 30-50 ppm of activated chlorine dioxide may be performed. The bath extends the shelf life even without the packaging. For an extended shelf life, the dipped fish is then stored in a modified atmosphere packaging having a mixture of nitrogen, oxygen and carbon dioxide. The bath includes the following ingredients in water for all fish:

| | |
|---|---|
| 0-2% | lactic acid |
| 5-10% | sodium phosphate |
| 5-10% | cultured dextrose |
| 5-10% | combination of Vitamin C, Vitamin E, |
| | citric acid, carnosic acid and rosamarinic acid |
| 5% | dark honey |
| 1½% | salt |
| .25% | lemon extract |

For salmon, 4-8 parts per million of Canthaxantin are added. This adds a pink color to the salmon and is not used with other fish. Other ingredients may be added to the wash for flavor or coloring.

The process is carried out by keeping the fish at 38° F. or below during the total process. The gassed atmosphere includes at least 40% carbon dioxide and the other 60% is a mixture of oxygen and nitrogen. Preferably the atmosphere would be 60% carbon dioxide, 20% oxygen and 20% nitrogen.

The sodium phosphate, the Duralox and dark honey all acts as antioxidants. The ingredients in Duralox are antioxidants in two modes. The amount of Vitamin C in Duralox may be supplemented to increase from 40 ppm to 400 ppm. The sodium phosphate is also an antibacterial and helps hold the water and the components of the solution. The goal is for the fish to hold 2% of the solution.

The cultured dextrose is preferably Microgard 200, available from Rhodia, and produces bactriocin, proprionic acid or proprionates. This inhibits fungus, mold and bacteria. The lactic acid helps the proprionic acid at a lower PH. Lactic acid also inhibits other bacteria from forming, specifically bacteria that produces lactic acid since it is already present.

The ingredients for the bath can also be used without packaging to extend the shelf life of the fish in a display case versus that of a prepackaged environment. With the extended shelf life, the fish can be provided in combination with other, food as a prepackaged meal.

Although specifically commercially available, cultured dextrose and Duralox have been mentioned, the equivalence may be substituted in the appropriate proportions. The use of as many natural ingredients such as honey as an anti-oxidant is preferred. Light honey may be used, but dark honey is more effective.

Although some of the ingredients have been used before in the bath treatment of fish, this specific combination of ingredients have not been brought together before to produce the synergistic effect of substantially increasing shelf life. The results produced are considered unexpected.

What is claimed:

1. A dip for preserving fish comprising:
lactic acid;
sodium phosphate;
cultured dextrose;
Vitamin C;
Vitamin E;
carnosic acid;
rosamarinic acid;
citric acid;
honey; and
salt.

2. The dip according to claim 1, wherein the proportions of the ingredients in a liquid are
0-2% lactic acid;
5-10% sodium phosphate;
5-10% cultured dextrose;
5-10% the combination of Vitamin C, Vitamin E, citric acid, carnosic acid and rosamarinic acid;
5% dark honey; and 1½% salt.

3. The dip according to claim l,inlcuding lemon extract.

4. The dip according to claim 1,including Canthaxantin

5. The dip according to claim 1, wherein Vitamin C is in the range of 400 ppm.

6. A process for preserving fish comprising:
dipping the fish in a bath including the dip of claim 1.

7. The process according to claim 6, including pre-washing the fish with water under pressure.

8. The process according to claim 6, including pre-washing the fish in a bath having 30-50 ppm of activated chlorine dioxide.

9. The process according to claim 6,including packaging the fish after dipping in an atmosphere of nitrogen, oxygen and carbon dioxide.

10. The process according to claim wherein the atmosphere is 20-40% nitrogen, 20% oxygen and 40-60% carbon dioxide.

11. A process for preserving fish comprising:
dipping the fish in a bath, which includes a dip, for a sufficient time to preserve the fish for at least 14 days without packaging.
